(19) United States
(12) Patent Application Publication
(10) Pub. No.: US 2017/0115833 A1
(43) Pub. Date: Apr. 27, 2017

(54) TOP BAR DISPLAY FOR AN AGRICULTURAL SYSTEM

(71) Applicant: CNH Industrial America LLC, New Holland, PA (US)

(72) Inventors: Natalia Lucas, Mundelein, IL (US); Bushra Ali, Bensenville, IL (US)

(73) Assignee: CNH INDUSTRIAL AMERICA LLC, New Holland, PA (US)

(21) Appl. No.: 14/923,781

(22) Filed: Oct. 27, 2015

(51) Int. Cl. G06F 3/0482; G06F 3/0484

(52) U.S. Cl. CPC G06F 3/0482; G06F 3/04847; G06F 3/04842; G06F 2203/04803

(57) ABSTRACT

An agricultural system including a vehicle, a controller; and a display mounted in the vehicle. The display is coupled to the controller and has a display area. The controller is configured to: present a top bar display along at least a portion of a top side of the display area; position a fixed central information section; and align a plurality of other sections to a left or a right position relative to the fixed central information section.

### BACKGROUND OF THE INVENTION

1. Field of the Invention

The present invention relates to an agricultural system, and, more particularly, to a display regime for presenting a top bar portion on a display associated with an agricultural vehicle system.

2. Description of the Related Art

Modern farming practices have developed to improve the speed and efficiency of the farm equipment used to plant, maintain, and harvest crops. For example, tractors include a global positioning system (GPS) and a controller in the tractor is configured to provide a topographical view of a field and to identify the location of the tractor within the field based on the GPS coordinates. In addition, multiple agricultural implements may be connected to the tractor. During planting, for example, the tractor may pull an air cart having multiple containers including one or more types of seed and/or fertilizer. The tractor may also pull a planter to plant the seeds.

The controller on the tractor may be configured to control operation of the implements connected to the tractor. Different models of each implement may include varying operating parameters such as capacity, rate of application, or number of rows. The operating parameters may also depend, for example, on the configuration or operating characteristics of the tractor or the location within the field. Each of the operating parameters needs to be configured prior to operation of the respective implement. Consequently, each implement typically includes a configuration module stored on the controller of the tractor to configure operation of the respective implement.

However, as the number of features on the agricultural implements increase so does the number of operating parameters and the complexity of configuring operation of the tractor and the connected implements. In addition, different implements such as the air cart and planter may interact with each other. Changing the configuration of a parameter on one of the implements may impact operation of the other implement.

In a known type of planting implement, seed planting or row units are attached to a toolbar extending transverse to the direction of planting. The toolbar is coupled to a tractor or other work vehicle suitable for pulling the planting implement along a field that is to be seeded to a crop. Each planting unit includes a ground penetrating assembly, often including one or more discs, for opening a seed trench or furrow in the ground as the planting implement is pulled across a field. Components of the ground penetrating assembly shape the bottom and sides of the seed trench, and a seed-metering device provides individual seeds at a controlled rate for deposit in the seed trench. Furrow closing components of each row unit close the seed trench in a controlled manner.

Agricultural planters are commonly used implements to plant seeds in soil. An agricultural planter can include a chassis that carries one or more storage tanks carrying seed, and chemical applications that are to be applied to the field during the planting operation, a hitch mechanism that attaches to a tractor or other implement pulled by a tractor, and a tool bar that row units can be connected to so they are carried by the chassis. The planter can also include a pneumatic system carried by the chassis that supplies pressurized air to transport the seeds or other particulate from the storage tanks to the row units.

Each row unit of the agricultural planter places seeds in the field. By having multiple row units working in unison as the planter is pulled across a field, many seeds can be effectively planted in an efficient manner.

The modern farmer faces the challenge of integrating many kinds of equipment starting with the vehicle itself, which can be coupled to all kinds of implements (planters, sprayers, seeders, tillage equipment etc.), and have various navigational controllers and high precision GPS receivers installed. These all lead to very complex setups and a large amount of data.

What is needed in the art is a robust system that allows for the presentation of data and selections in an intuitive and efficient manner on a display.

### SUMMARY OF THE INVENTION

The present invention provides a display regime that allows information and selections to be available along a top bar of a screen.

The invention in one form is directed to an agricultural system including a vehicle, a controller; and a display mounted in the vehicle. The display is coupled to the controller and has a display area. The controller is configured to: present a top bar display along at least a portion of a top side of the display area; position a fixed central information section; and align a plurality of other sections to a left or a right position relative to the fixed central information section.

The invention in yet another form is directed to a method of displaying information on a display for an agricultural system that includes a vehicle, and a controller, the display being mounted in the vehicle, the display is coupled to the controller, the method comprising the steps of: presenting a top bar display along at least a portion of a top side of the display area; positioning a fixed central information section; and aligning a plurality of other sections to a left or a right position relative to the fixed central information section.

An advantage of the present invention is that the clock is centered and the other selection or information in the top bar is positioned relative to the central clock display.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematic representation of a complete agricultural system using an embodiment of a display method of the present invention for rendering top bars on a display;

FIG. 2 is a depiction of an implement of FIG. 1 that is coupled to the tractor and provides data for the display in at least the status drawer of the present invention;

FIG. 3 is a depiction of a display of a runscreen illustrating performance details of the tractor and implement of FIGS. 1 and 2;

FIG. 4 is a depiction of a top bar that can be positioned along a top of the screen of FIG. 3; and

FIG. 5 is a depiction of another embodiment of a top bar display of the present invention that can be positioned along a top portion of the screen of FIG. 3.

Corresponding reference characters indicate corresponding parts throughout the several views. The exemplification set out herein illustrates one embodiment of the invention, in one form, and such exemplification is not to be construed as limiting the scope of the invention in any manner.

### DETAILED DESCRIPTION OF THE INVENTION

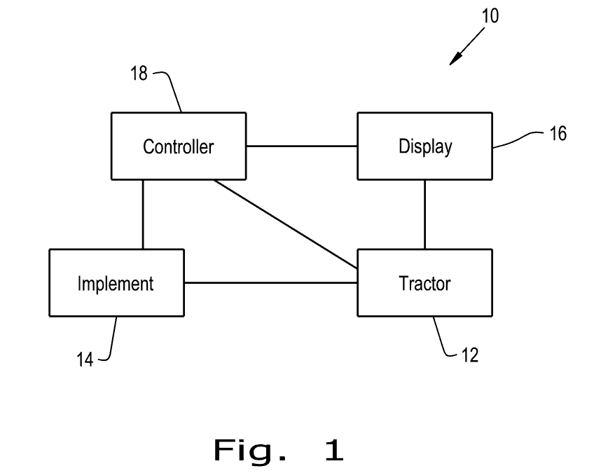

Referring now to the drawings, and more particularly to FIG. 1, there is shown an embodiment of an agricultural system 10 having a tractor 12, an implement 14 and a display 16 that is incorporated in tractor 12. Display 16 is an interactive display 16 configured to provide information to a user and allow the user to direct the operation of tractor 12 and/or implement 14. A controller 18 receives information from sensors on implement 14 and tractor 12, processes, stores and displays selected portions of that information and other stored information such as setup information and configuration selections. The displaying of information and control features on display 16 takes into account needed setup and configuration aspects of the agricultural system 10.

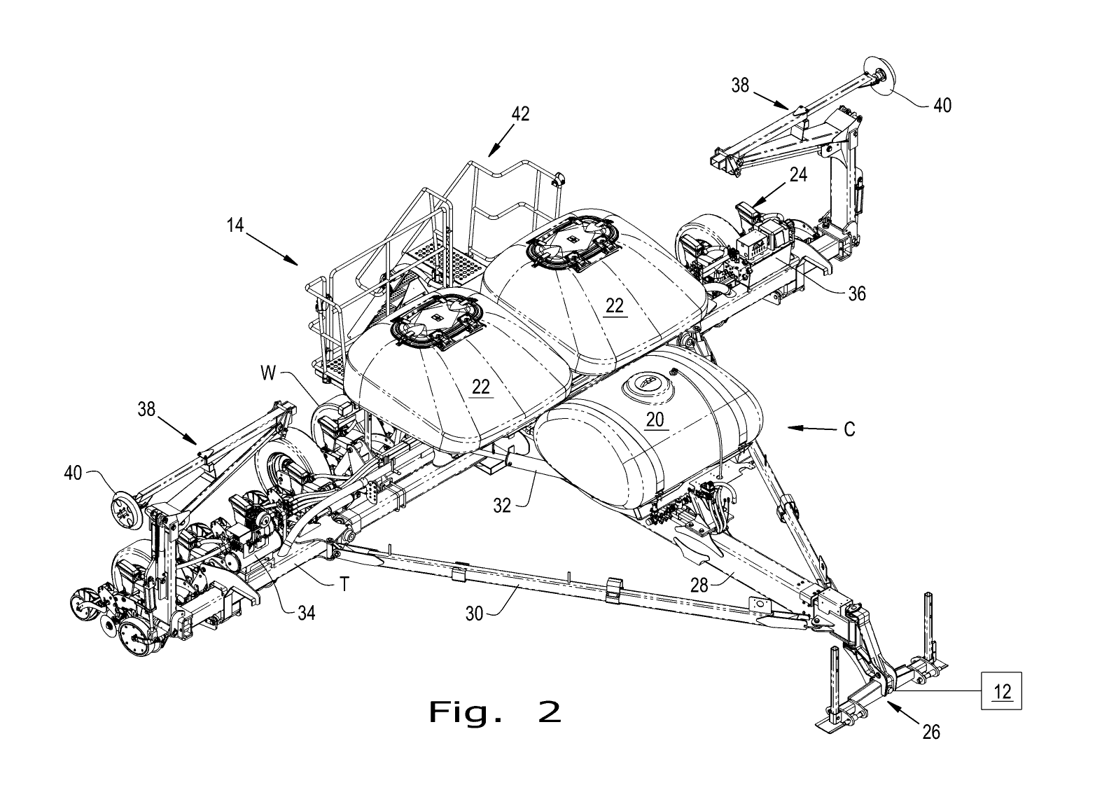

Now, additionally referring to FIG. 2, there is shown some details of a typical implement 14 in the form an agricultural planter 14 which generally includes a chassis C forming a support structure for components of the planter 14 that can be formed by a hitch assembly at a front of the planter 14 connected to a tool bar T, main wheels W carried by the chassis near a rear of the planter 14, one or more storage tanks 20 and 22 that can be filled with seed or other agriculture material carried by the chassis, and a plurality of row units 24 connected to the tool bar T and arranged laterally across a length of the tool bar T so that they are carried by the chassis. The chassis C can include a hitch 26 configured to be connected to a tractor 12 or other agricultural implement (not shown) so that the planter 14 can be pulled in a forward direction of travel. The hitch 26 can be integrally formed with or connected to a hitch bar 28 that is connected to the tool bar T by bracing bars 30 and one or more cylinders 32. As can be seen, the planter 14 can also have various hydraulic, pneumatic, and electrical lines (unnumbered) throughout to support various cylinders and systems that are included on the planter 14, such as a pneumatic system 34 connected to the tool bar T and an electric generator 36 also connected to the tool bar T. A marking device 38 can be connected to each lateral end of the tool bar T and extendable so that a marking disc 40 of the marking device 38 can create a line in the soil as the planter 14 is pulled that helps a user in positioning the planter 14 to create subsequent rows. A stair assembly 42 can be mounted to the back of the planter 14 to allow for an operator to access the storage tanks 22.

While a planter 14 is shown in detail it is to be understood that any agricultural implement 14 can be utilized. Further, although a towing of implement 14 by tractor 12 is illustrated herein it should be understood that tractor 12 may be any agricultural, construction, or forestry vehicle that can be coupled to various implements 14.

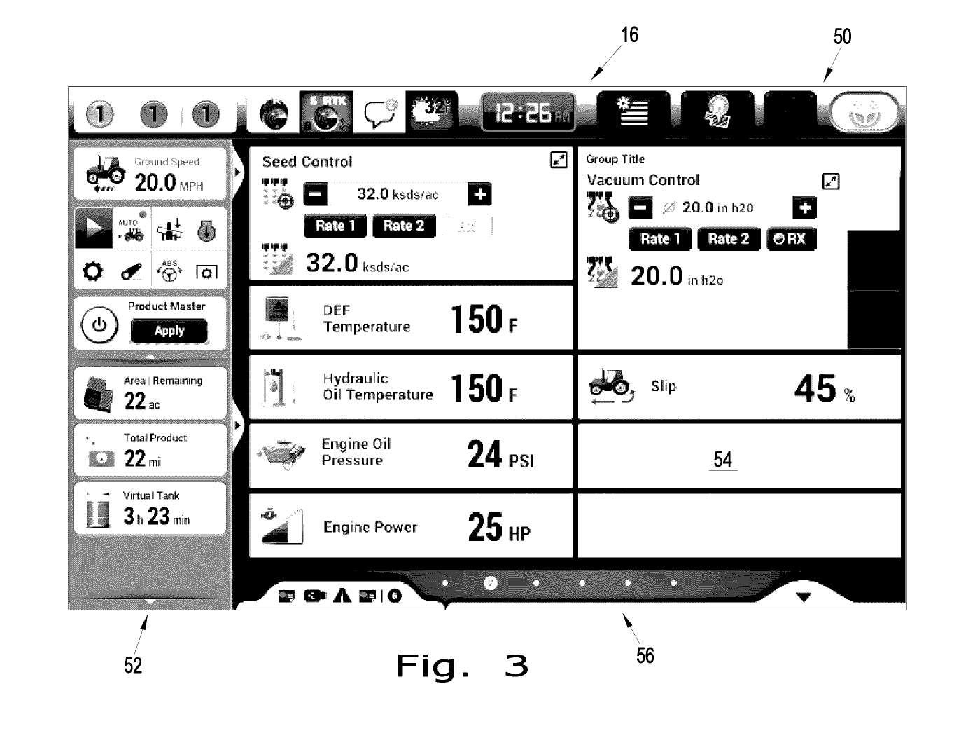

Now, additionally referring to FIG. 3, there is shown a screen rendering of operating details selected by the user relative to elements of tractor 12 and for implement 14. For example, the seed control of planter 14 and the vacuum performance of planter 14 is illustrated as well as the DEF temperature of tractor 12. A use of a Phoenix (12 inch) or of a Hawk (8 inch) display 16 is contemplated and a User Experience (UX) framework is designed to consistently display navigational items and provide user customizable areas for equipment controls and feedback.

The Phoenix Display is divided into several distinct screen regions: a Top Bar 50, a Left Hand Area 52, a Runscreen 54, and a Bottom Bar 56.

The Top Bar 50—Provides access to global level information, tools, and setups. The Top Bar 50 is shown all the time, is never covered by popups, and includes fault lamps, status, Global Navigation Satellite System (GNSS) and Guidance statuses, as well as access to the Menu and the Home Screen.

The Left Hand Area 52 (LHA)—Contains vehicle status and performance data; with views and controls needed as the operator drives and bounces through the field. The LHA 52 is shown all the time to the user, and is never covered by popups. The upper portion is dedicated to vehicle 12. The upper portion can show either regulatory or platform requirements. This portion is not changeable by the user. The lower portion is changeable by the user, with default displays provided. The expandable drawers show additional info when selected by the operator, just one touch away from the runscreen 54.

The Runscreen 54—Contains controls that users need daily in order to efficiently operate the equipment 10 and productively accomplish the job. The Runscreen 54 has views and controls you needed to drive in the field, for example, Target rate control, a planter bar graph, Combine ACS engage, and loss monitors. Layouts of the Runscreen 54 are changeable by the user, with defaults being provided.

The Bottom Bar 56—Contains runscreen 54 page controls, status and shortcuts drawers. These are shown all the time, are never covered by popups. The regions help to organize the data and provide the user with a system for understanding where certain types of data, controls, or interactions are available. A particularly distinctive feature is the way the data is organized, with all the setups that are done once in a while being stored under a menu (accessed through Top Bar 50).

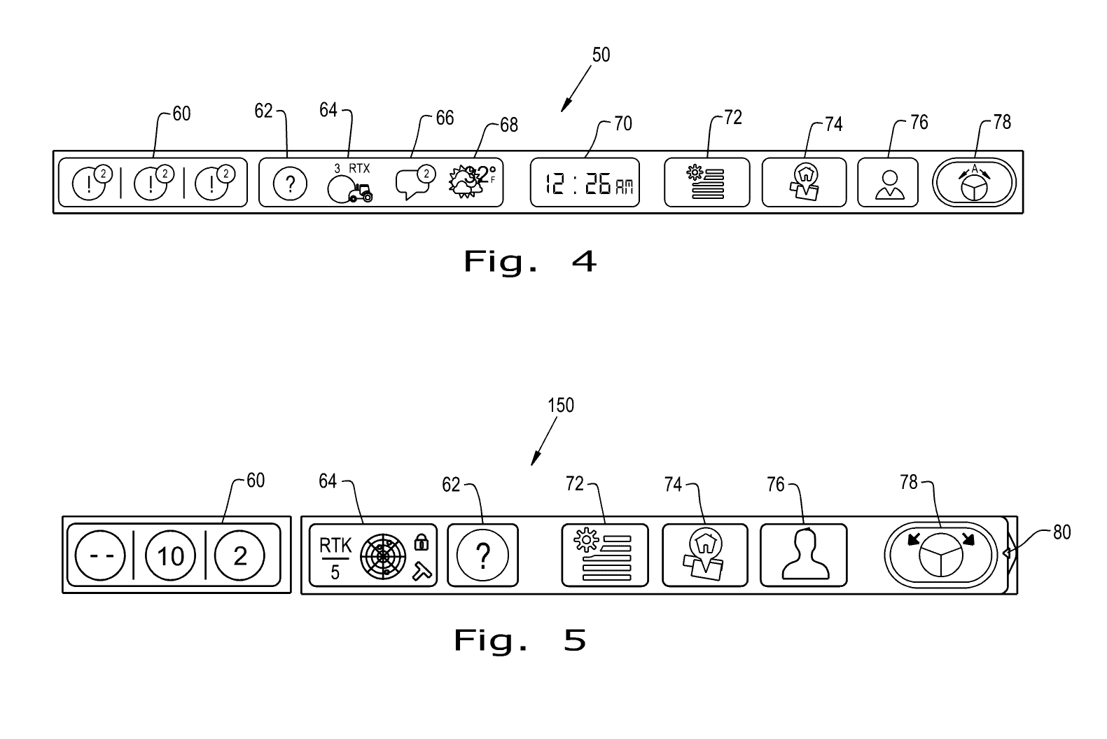

Now, additionally referring to FIGS. 4 and 5, there are shown some additional features of a top bar 50 and a top bar 150. Top bar 50 represents the uppermost, full width region, which is delimited by a gray background. Top bar 50 always stays on the screen and is not covered by pop-ups or other type of user interface (UI) overlays. The Top Bar 50 region provides access to global level information, tools, and setups, which include: an Alerts Tray 60, a Help button 62, a GNSS Status 64, Instant Messages 66, Weather 68, a Clock 70, a Menu button 72, a Home button 74, a Login selection 76, and an Auto Engage Button 78. The Clock 70 shows the time and divides the top bar content into left and right sections. The position of clock 70 is fixed in the center of top bar 50. The amount of items displayed on both sides of clock 70 may differ depending on the available equipment and services. If any of the buttons to the left or right are absent in a given setup, the remaining elements will be aligned to the left or right of clock 70 correspondingly. For example, if auto-guidance system 78 is not available then, the far right auto-engage button 78 will not show up in top bar 50 and the buttons 72, 74 and 76 to the right of clock 70 will be shifted and aligned to the right margin.

A Top Bar 150 concept has been transitioned to Hawk, (see FIG. 5) a much smaller display as follows: The top bar 150 represents the uppermost section of the LHA 52, represented by the faults tray 60 which can be extended to the full width overlaying the runscreen 54. The user taps on the open arrow pressable space (which is bigger than the visual arrow in order to ensure good touchablity) or slide from left to right to expand the full top bar 150.

To close top bar 150, the user presses on the close arrow pressable space 80 or slides a finger from right to left over arrow 80. The closing of the extended top bar 150 can be done only by the user with some exceptions, such as when the runscreen 54 page contains a map or a Universal Terminal (UT) full screen User Defined Window (UDW). This feature is added in case the user would prefer not to place anything on the top two grid cells of the runscreen 54 or keep the top bar 150 always extended. The region of the screen that is to be covered by the extended top bar 150 must not be covered by pop-ups or other type of UI overlays. The goal of the Top Bar 50, 150 region is to provide access to global level information, tools, and setups, which include providing the display with a region that will be always visible and contain access to setups, faults and statuses, thereby solving user experience issues.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An agricultural system, comprising:
a vehicle;
a controller; and
a display mounted in said vehicle, said display being coupled to said controller and configured with a display area, said controller being configured to:
present a top bar display along at least a portion of a top side of said display area;
position a fixed central information section; and
align a plurality of other sections to a left or a right position relative to said fixed central information section.

2. The agricultural system of claim 1, wherein said fixed central information section is a clock display.

3. The agricultural system of claim 2, wherein said plurality of other sections includes an alerts tray positioned to a far left of all other sections.

4. The agricultural system of claim 3, wherein said plurality of other sections includes at least one selection button.

5. A display system for use with an agricultural vehicle, comprising:
a controller; and
a display mountable in the agricultural vehicle, said display being coupled to said controller and configured with a display area, said controller being configured to:
present a top bar display along at least a portion of a top side of said display area;
position a fixed central information section; and
align a plurality of other sections to a left or a right position relative to said fixed central information section.

6. The display system of claim 5, wherein said fixed central information section is a clock display.

7. The display system of claim 6, wherein said plurality of other sections includes an alerts tray positioned to a far left of all other sections.

8. The display system of claim 7, wherein said plurality of other sections includes at least one selection button.

9. A method of displaying information on a display for an agricultural system that includes a vehicle, and a controller, the display being mounted in the vehicle, the display is coupled to the controller, the method comprising the steps of:
presenting a top bar display along at least a portion of a top side of the display area;
positioning a fixed central information section; and
aligning a plurality of other sections to a left or a right position relative to said fixed central information section.

10. The method of claim 9, wherein said fixed central information section is a clock display.

11. The method of claim 10, wherein said plurality of other sections includes an alerts tray positioned to a far left of all other sections.

12. The method of claim 11, wherein said plurality of other sections includes at least one selection button.
